(19) United States
(12) Patent Application Publication
(10) Pub. No.: US 2008/0297011 A1
(43) Pub. Date: Dec. 4, 2008

(54) INTEGRATED CONTROLLER/MOTOR WITH THERMAL OVERLOAD SENSOR

(76) Inventors: Daniel E. Delaney, Fort Wayne, IN (US); Vijayaraghavan Devarajan, Andhra Pradesh (IN); Robert Keith Hollenbeck, Fort Wayne, IN (US); Justin Brubaker, Lafayette Hills, PA (US); Bruce Calvin Ley, Ossian, IN (US)

Correspondence Address: General Electric Company;GE Global Patent Operation, PO Box 861, 2 Corporate Drive, Suite 648, Shelton, CT, 06484, US

(21) Appl. No.: 11/756,660

(22) Filed: Jun. 1, 2007

(51) Int. Cl. H02K 11/00; H02H 7/08

(52) U.S. Cl. 310/68 C; 310/68 R; 361/26

(57) ABSTRACT

An integrated controller/motor energized by a power supply includes a controller that has controller circuits and a pair of controller lead lines connectable in circuit between the power supply and the controller circuits. The integrated controller/motor also includes a motor that has a first motor winding and a second motor winding each in circuit with the controller circuits and a thermal overload sensor located in direct proximity to the first motor winding and the second motor winding. The thermal overload sensor may be connected in series with at least one of the controller lead lines. A method of protecting an integrated controller/motor from thermal overload is also presented.

### BACKGROUND OF THE INVENTION

1. Field of the Invention

The subject matter described herein relates generally to devices and methods for sensing an abnormal condition of a motor and, more particularly, to devices and methods for thermal overload protection for a motor.

2. Related Art

Thermal overload protection for electric motors may be used to prevent abnormally high temperatures caused by excessive current conditions brought about by a loss of phase, a dangerous overload condition and/or a locked rotor/shaft condition.

Various devices for preventing thermal overload are known. For example, U.S. Pat. No. 2,909,719 describes a motor protective means for a three phase motor that has a thermal switch that includes a metal strip or fin and which is disposed between windings. The switch is connected to a relay that is, in turn, connected to relay switches that are directly in line with the windings. In operation, thermal switch remains closed during normal operation of the motor and, upon excessive heating of the windings, will open and cause the relay switches to prevent current to flow through the motor windings.

In another example, U.S. Pat. No. 3,127,531 illustrates a thermal switch protector for a motor. The thermal switch protector is connected to a relay, in turn, connected to relay switch that switches current directly to the windings. A protector is connected directly to the windings for directly switching power to the windings.

A further example, in accordance with more recently developed devices for preventing thermal overload, generally uses a software algorithm to provide safety protective functions. U.S. Pat. No. 7,042,180 shows a motor control system for a brushless and a sensorless DC motor for driving a compressor, pump or other application, includes an off-the-shelf motor control integrated circuit having an input for disabling power outputs to the motor phase coils. A protection and fault detection circuit uses a back EMF sampling circuit coupled to the motor phase coils and momentarily disables power to the motor phase coils, via the motor control integrated circuit input, to determine if the motor rotor is rotating. The system also monitors supply voltage, supply current, temperature, and motor speed limits to detect faults and protect system components.

However, to date, no suitably simple and reliable device or method of providing thermal overload protection for a motor is available.

### BRIEF DESCRIPTION OF THE INVENTION

In accordance with an embodiment of the present invention, an integrated controller/motor energized by a power supply comprises a controller that comprises controller circuits and a pair of controller lead lines connectable in circuit between the power supply and the controller circuits. The integrated controller/motor also comprises a motor that comprises a first motor winding and a second motor winding each of which are in circuit with the controller circuits and a thermal overload sensor located in direct proximity to the first motor winding and the second motor winding. The thermal overload sensor may be connected in series with at least one of the controller lead lines.

In accordance with another embodiment of the present invention, a method of protecting an integrated controller/motor from thermal overload is provided. In accordance with the method, the controller/motor is connected to a power source and the controller/motor includes controller circuits for controlling energization of multiple windings of the motor. The method comprises locating a thermal overload sensor in, on or between two windings; and configuring the sensor to switch the supply of energy between the power source and the controller circuits.

### BRIEF DESCRIPTION OF THE DRAWINGS

The following detailed description is made with reference to the accompanying drawings, in which:

FIG. 1 is a diagram showing a thermal sensor in circuit with a motor and a controller in accordance with one embodiment of the present invention;

FIG. 2 is a diagram, from a side view, showing the thermal sensor of FIG. 1 mounted in a pocket provided between motor windings;

FIG. 3 is a top view, of a portion of the diagram of FIG. 2, showing in more detail the thermal sensor and the pocket; and

FIG. 4 is a flow diagram showing a method in accordance with another aspect of the present invention.

### DETAILED DESCRIPTION OF THE PREFERRED EMBODIMENT

One embodiment of the present invention concerns a simple and a reliable device and a method for providing thermal overload protection for a motor. In accordance with one aspect of the invention, a thermal overload sensor is located in, on or between windings of an integrated controller/motor and is connected in series and between a power source and controller circuits. With this arrangement, no potential software malfunctions can prevent function of thermal overload protection for the controller/motor. Furthermore, the use of an ICM thermal overload sensor in accordance with this embodiment provides full protection if controller software does fail. In addition to the expanded safety protection offered by the present embodiment, this arrangement can simplify third party approval processes and simplify third party agency evaluations as it can be classified as a Type 1 control per UL/IEC standard 60730-1A. Also since the thermal overload protector removes power to the integrated controller/motor, (sometimes referred to herein as “ICM”) it essentially overrides all other protective features and eliminates the need for software evaluation. Further, the present arrangement allows the motor and controller to cycle on and off to avoid unsafe abnormal conditions and inconvenience of a one-time thermal protector such as those devices described in the Background section above.

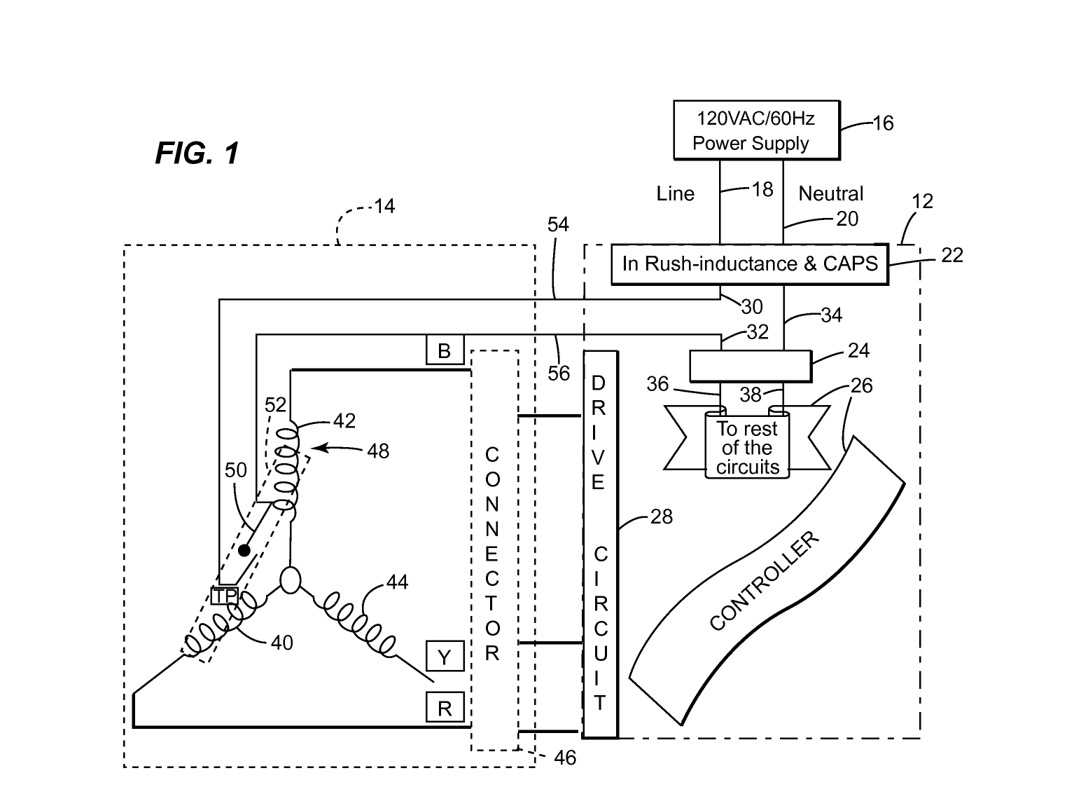

Referring now to FIG. 1, an integrated controller/motor in accordance with one embodiment of the present invention is illustrated generally at 10. In this embodiment, the integrated controller/motor 10 comprises a controller 12 and a motor 14. The controller 12 is connected to a common power supply 16 that may provide 120 volts AC at 60 Hertz (Hz) in accordance with the U.S. standard or 220 volts at 50 Hz in accordance with the European standard. The power supply 16 energizes power lead lines commonly referred to as “line” 18 and “neutral” 20.

The controller 12 comprises EMI filtering/transient protection 22, an inrush current limiting circuit 24, controller circuits 26 and a drive circuit 28. The EMI filtering/transient protection 22 is connected in circuit with the line 18 and neutral 20 and may comprise any suitable combination of inductors and capacitors that provides a well known function of transforming the input power to a suitably filtered voltage and current. The inrush current limiting circuit 24 is connected in circuit with the EMI filtering/transient protection 22 via lines 30, 32 and 34 and functions to protect the controller from high power line surges and electromagnetic emissions. The controller circuits 26, are connected in circuit with the inrush current limiting circuit 24 via lines 36 and 38 and, provide for the operational control of the motor. The controller circuits 26 may also provide for the sensing of various aspects of the motor operation such as speed and torque. The drive circuit 28 is in circuit, and operated by, the controller circuits 26 and may comprise sets of insulated gate bipolar transistors or other similar drive circuits.

The motor 14 may be of a three phase type as shown, although, it will be appreciated that a single phase, DC or other motor winding configuration is contemplated in the practice of the present invention. As illustrated the motor 14 comprises coil windings 40, 42 and 44 and a connector 46. The coil windings 40, 42 and 44 are connected to be energized as appropriate by the controller circuits 26 via the drive circuit 28 through connector 46.

In accordance with a feature of the present invention, a thermal sensor 48 is located between the windings 42 and 44 of the motor 14. The thermal sensor 48 may comprise a thermal overload protector switch 50, thermal protector body 52 and protector switch lead lines 54 and 56. The thermal overload protector switch 50 may comprise a bi-metal, a heater or any other suitable thermal overload construction. One suitable construction is available under the mark KLIXON and manufactured by the Sensata corporation and available at the Internet address www.sensata.com. In the present embodiment, the protector switch 50 is configured to be normally closed. The protector switch lead lines 54 and 56 are connected with lines 30 and 32 such that the thermal sensor is connected in series with the inrush current limiting circuit 24 and the controller circuits 26. With this arrangement, the thermal overload protector switch 50 functions so as to open upon high thermal conditions of the windings 42 and 44 and thereby prevent power being conducted to the controller circuits 26.

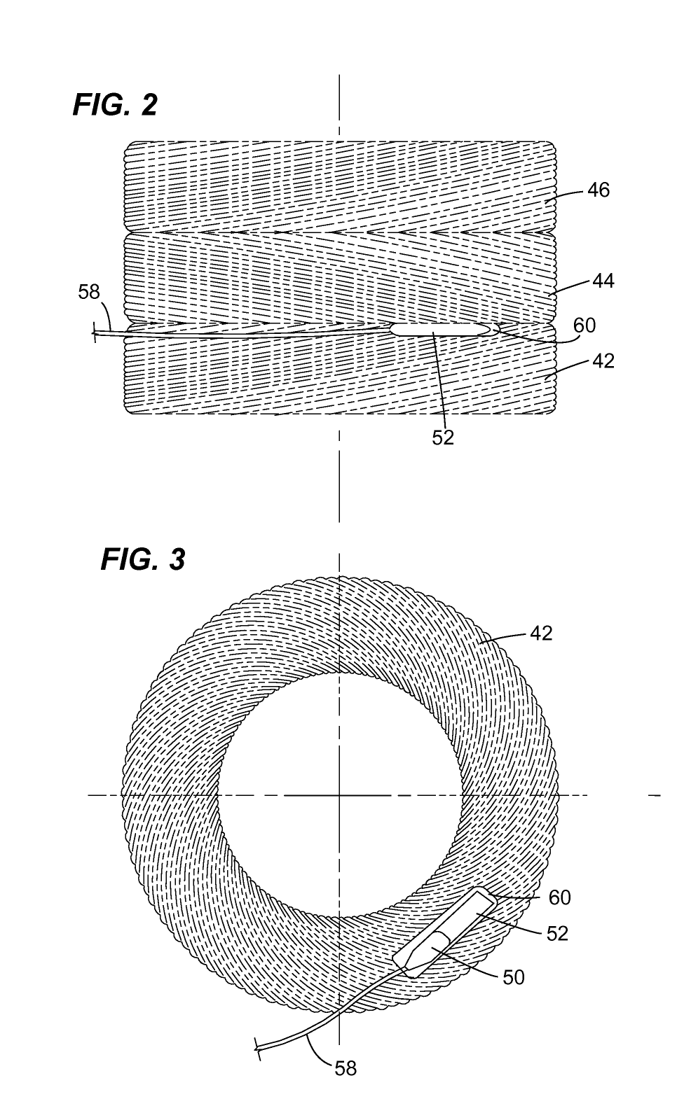

Referring now to FIGS. 2 and 3, a particular embodiment of the protector switch may be provided wherein the protector switch lead lines 54 and 56 may be encased in a sheath 58 and the thermal overload protector switch 50 may be located within a pocket 60 formed in, e.g., the end turns (not numbered) of the winding 42. The thermal protector body 52 is composed of a thermally conductive material, e.g., a steel case, and has a generally rectangular shape. It may be adhered to a number of end turns of the winding 42 using, e.g., varnish, epoxy or mechanical tie cords individually or together.

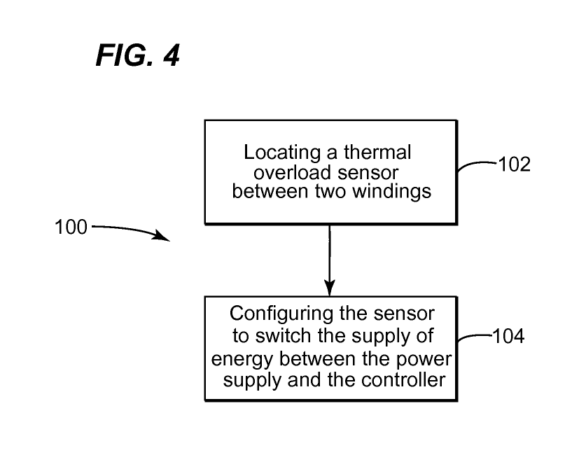

Turning to FIG. 4, a method of protecting an integrated controller/motor from thermal overload in accordance with another embodiment of the present invention is shown generally at 100. In accordance with this method, a controller/motor, such as that described above, is connected to a power source and the controller/motor includes controller circuits for controlling multiple energized windings of the motor. As shown at 102, the method comprises locating a thermal overload sensor between two windings and, as shown at 104, the method further comprises configuring the sensor to switch the supply of energy between the power source and the controller circuits.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

What is claimed is:

1. An integrated controller/motor energized by a power supply, the integrated controller/motor comprising:
a controller comprising controller circuits and a pair of controller lead lines connectable in circuit between the power supply and the controller circuits;
a motor comprising a first motor winding and a second motor winding each being in circuit with the controller circuits; and
a thermal overload sensor located in direct proximity to the first motor winding and the second motor winding, the thermal overload sensor being connected in series with at least one of the controller lead lines.

2. The device of claim 1, wherein the thermal overload sensor is located between the first motor winding and the second motor winding.

3. The device of claim 2, wherein the thermal overload sensor comprises a thermal overload protector switch including a pair of protector switch lead lines connected in series with one of the input lead lines.

4. The device of claim 3, wherein the thermal overload protector switch comprises at least one of a bi-metal and a heater type.

5. The device of claim 1, wherein the thermal overload sensor is mounted in, on or between adjacent end turns of the first motor winding and the second motor winding.

6. The device of claim 1, wherein the controller further comprises EMI filtering/transient protection and an inrush current limiting circuit each disposed in circuit between the power supply and the controller circuits and connected to each of the controller lead lines and wherein the thermal overload sensor is connected in between the EMI filtering/transient protection and the inrush current limiting circuit.

7. A method of protecting an integrated controller/motor from thermal overload, the controller/motor being connected to a power source and the controller/motor including controller circuits for controlling energization of multiple windings of the motor, the method comprising:
locating a thermal overload sensor in, on or between two windings; and
configuring the sensor to switch the supply of energy between the power source and the controller circuits.
